(19) United States
(12) Patent Application Publication
(10) Pub. No.: US 2012/0004959 A1
(43) Pub. Date: Jan. 5, 2012

(54) SYSTEMS AND METHODS FOR MEASURING CONSUMER AFFINITY AND PREDICTING BUSINESS OUTCOMES USING SOCIAL NETWORK ACTIVITY

(75) Inventors: Daniel Benyamin, Beverly Hills, CA (US); Michael Hall, Valencia, CA (US)

(73) Assignee: CitizenNet, Inc., Los Angeles, CA (US)

(21) Appl. No.: 13/103,990

(22) Filed: May 9, 2011

Related U.S. Application Data
(60) Provisional application No. 61/332,562, filed on May 7, 2010.

(51) Int. Cl. G06Q 30/00

(52) U.S. Cl. 705/14.4

(57) ABSTRACT

Systems and methods for identifying and quantifying user activities within a social network and for generating affinity scores for activities that result in a desired outcome are described. One embodiment of the method of the invention includes receiving activity information at a server from user devices, building streams of activity information using the server, relating the streams of activity information to topic data using the server, assigning weights to specific types of activity information that are associated with an advertising campaign using the server, and calculating an affinity score with respect to the advertising campaign based upon the streams of activity information and the weights using the server.

### RELATED APPLICATION

The current application claims priority to U.S. Provisional. Application No. 61/332,562, filed May 7, 2011, the disclosure of which is incorporated herein by reference.

### BACKGROUND

The present invention relates to messaging and social network systems, and in particular, to measuring consumer affinity and predicting business outcomes using social network activity systems and methods.

Social networks have increased in popularity over the years and provide a unique and expansive communication network between users. However, with this increased popularity and expansiveness the ability to measure and/or extract data from the messages or user interactions with the social networks has become daunting.

### SUMMARY OF THE INVENTION

Systems and methods in accordance with embodiments of the invention identify and quantify user activities within a social network and generate affinity scores for activities that result in a desired outcome.

One embodiment of the method of the invention includes receiving activity information at a server from user devices, building streams of activity information using the server, relating the streams of activity information to topic data using the server, assigning weights to specific types of activity information that are associated with an advertising campaign using the server, and calculating an affinity score with respect to the advertising campaign based upon the streams of activity information and the weights using the server.

### BRIEF DESCRIPTION OF DRAWINGS

FIG. 1 is a system diagram illustrating a measurement and scoring social network activities system in accordance with various embodiments of the invention.

FIG. 2 is a flow chart illustrating a process for determining affinity with campaigns based upon user activities in accordance with embodiments of the invention.

FIG. 3 is a flow chart illustrating a process for measuring and scoring social network activities in accordance with embodiments of the invention.

FIG. 4 is a flow chart illustrating another process for measuring and scoring social network activities in accordance with embodiments of the invention.

FIG. 5 is table illustrating an example log of a stream of signals in accordance with an embodiment of the invention.

FIGS. 6A-6C are tables illustrating weights associated with specific activities within different campaigns in accordance with embodiments of the invention.

FIG. 7 is a flow chart illustrating a process for determining intent and/or action patterns in accordance with embodiments of the invention.

FIG. 8 is a flow chart illustrating a process for determining weights that are assigned to specific actions when determining affinity with a particular campaign in accordance with an embodiment of the invention.

FIG. 9 is a chart conceptually illustrating data that may be derived in accordance with embodiments of the invention relating opening day box office returns to the average number of people that have an affinity score above 0.8 for a given time period.

### DESCRIPTION

The present invention provides systems and methods to identify and quantify user activities within online social networks and to generate affinity scores for activities that result in a desired outcome.

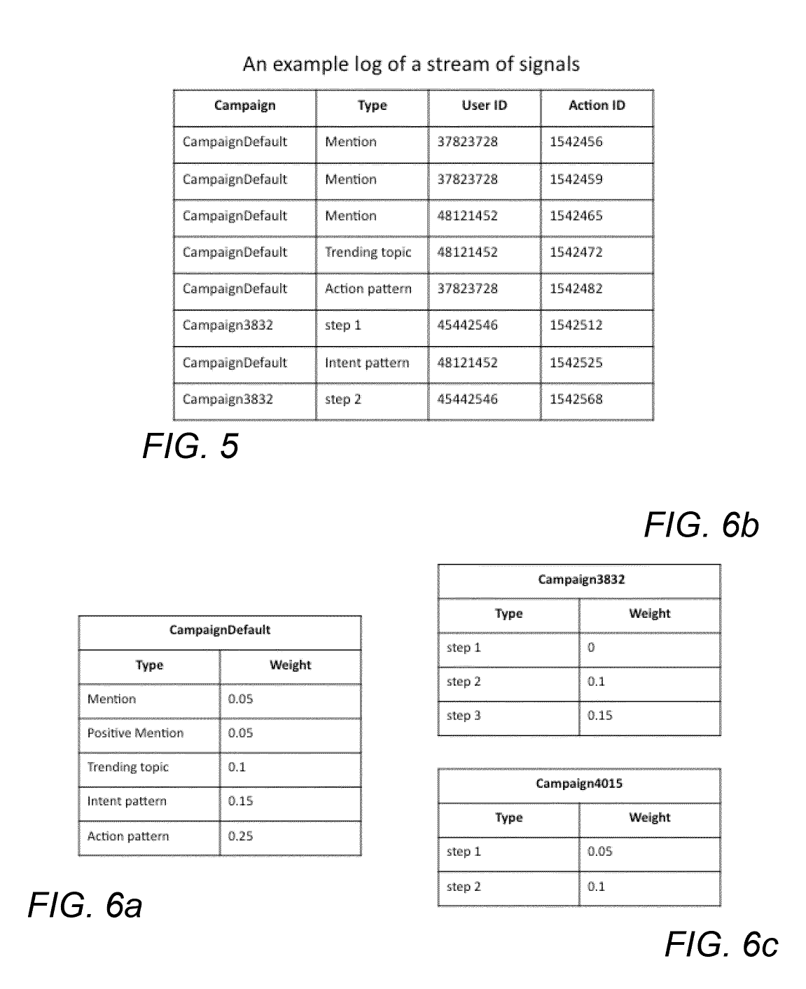

In many embodiments, an affinity system is provided that builds an “affinity” score for individuals based on their activities on social networks. To build the affinity scores the system retrieves or identifies signals that represent or can be identified as user activity or messages in one or more social networks. In several embodiments, a particular set of keywords is chosen. Signals matching these keywords are fetched on a frequent or specified basis from social networks such as Twitter and Facebook, or social applications such as location based services. A signal in one embodiment can be a time ordered set of messages or other activities (such as logging in, purchasing, etc). A union of all signals that match specific criteria is identified as a “stream”. An example log of a stream of signals in accordance with an embodiment of the invention is illustrated in FIG. 5.

Streams can be classified by topic. For example, one may have several streams that fall into the “movie” classification or topic, and other streams that may fall into the “television” classification.

The signals may take a number of forms including but not limited to the following:
a mention, where the keyword is used in any context;
a positive mention, where the user mentions the keyword in a positive context;
a trending topic, where the user mentions a phrase that is rising in popularity;
an intent pattern, which is some pattern that represents the intention of the user to do something; and
an action pattern, which is some pattern that represents an activity that someone has verifiably done.

In addition to these signals, a “campaign” can be associated with a stream. A campaign is an application that interacts with users and captures who is interacting with the application and what a user may be expressing. Every stream has a default campaign, and may have one or more additional campaigns associated therewith. Examples are illustrated in FIGS. 6A-6C.

For example, a campaign may be a contest whereby a participating user chosen at random can win a prize. The user administering this campaign may be interested in seeing who participates in the contest, who is exposed to the contest, and who wins the contest. Each of these activities or events may be considered a signal. The system in one embodiment logs at runtime when each of these activities occur, along with a unique identifier and a user identifier.

### Intent and Action Patterns

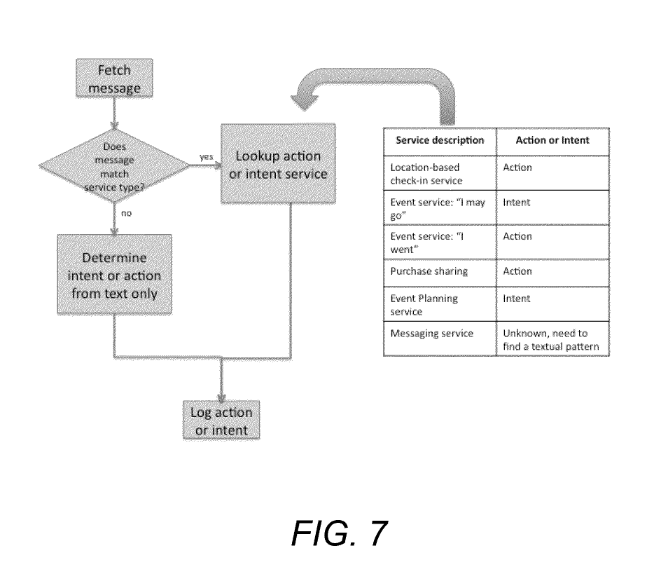

An intent or action pattern in one embodiment is a signal that can be programmatically determined to express intent or action. A signal may for example come from a service that implicitly expresses intent or an action. For example, a live event service may allow users to login with a social networking account and indicate to their friends that they may attend an event. This generates a signal that implies an intention on the part of that user and the event. If the service lets the user indicate that they actually went to an event, then that would generate a signal denoting action. Many other such services exist, and it would be determined during setup by an administrator or by a particular set of system criteria whether a service contributes knowledge of intent or action. Some services do not denote such semantics; in these cases an analysis of the text of the message may indicate intent or action. A process for determining intent and/or action patterns in accordance with embodiments of the invention is illustrated in FIG. 7.

### Applying Weights to Signals

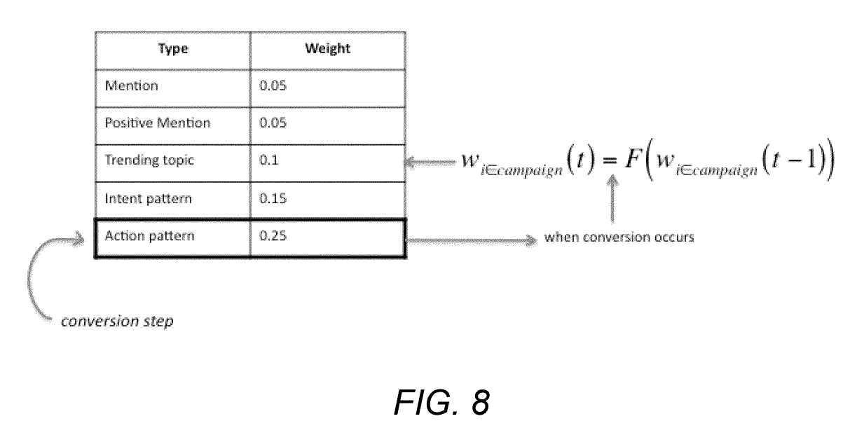

For every campaign, a “conversion” step is defined. When a user performs this action or a particular action is identified or otherwise marked as performed or completed, this implies the user has reached some business goal (e.g., a business goal has been completed). For example, if a campaign includes a giveaway to promote a car, one may want to track the number of participants in the giveaway and the number of people request more information about a car, e.g., a click on a link that directs the user to more information about the car. Clicking this link is considered a conversion step since it aligns with a business goal of having people visit the car site. The default campaign has as the conversion step anything that meets the “action” pattern. A process for determining weights of actions in accordance with embodiments of the invention is illustrated in FIG. 8.

For each type of signal or action, the system stores a number w that indicates the likelihood that someone who performs that action will reach the conversion step. Each time a conversion occurs, a function F inspects the previous actions the user has performed prior to the conversion step. The weights for these actions are increased by some amount, governed by the update function F. Similarly, in one embodiment, the weights for actions not taken by the user are decreased by some amount governed by this function. Thus, the weights are time varying, and iterated upon each user conversion.

### Affinity Score

The affinity score for a user is simply the weighted sum of all actions the user has taken:

$${affinity}_{c} = {Σ}_{i ∈ s , c} {w}_{i} {a}_{i}$$

$$where$$

$${Σ}_{i ∈ s , c} {w}_{i} = 1$$

wᵢ is a weight for an action i, aᵢ takes the values 1 or 0, denoting the that the user has taken part in that action, s is a particular stream and includes a default and any additional campaigns, and c is a particular class the stream belongs to. Although a specific process for computing affinity is disclosed above, any of a variety of processes can be utilized that are appropriate to a specific application in accordance with embodiments of the invention

In several embodiments, every user logged in the system receives an affinity score. This score allows marketers or other similarly interested systems or users to gain insight into who are their best customers versus those who just have a passing interest. It also lets the marketer gain insight into how the affinity scores may trend over time. The scoring of users is determined both by measuring the network (the default campaign) and by the marketers' own outreach efforts.

### Keyword Optimization

A defined and unchanging set of keywords are used and in one embodiment ensemble sets of keywords are used.

The system or users of the system may build a number of streams that have distinct keywords, but topically related. For example, one may make ten streams for ten different movies. Although the keywords for each stream will differ (different movie titles, actors, etc), each one is a movie and will therefore display similar social networking dynamics. A set of end point parameters may be defined, e.g., by a marketing manager, that indicates a “bottom line” business goal, such as revenue, associated with the streams that have been defined. The affinity score can be optimized as a measure and predictor of this stated business goal in the following manner:
1. Record a known, fundamental business result that is related to a stream. For example, if a stream was built for a movie, and the opening day box office result for that movie is known, then this number should be recorded.
2. Record the average number of users for a certain time period before the measure took place that had an affinity score above a certain threshold. In the above example, one can record the number of users with an affinity score above 0.8 7 days before the movie has opened.
3. Repeat the tabulation of additional pairs of numbers for all movie streams until all a posteriori information has been recorded.
4. Generate a linear regression of the data.
5. If the regression is not well correlated with the data (by looking at the MSE or R² of the fit), modify the values wᵢ so that the error is minimized.

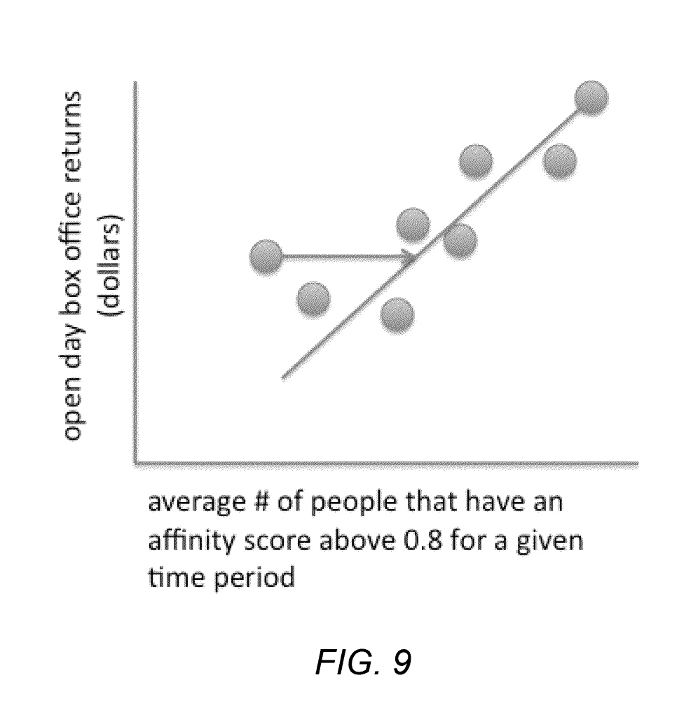

In the illustration in FIG. 9, most points fall on an approximately linear curve, except for one. The weights can be modified so that this point can move across the X-axis (the Y-axis is assumed fixed), without impacting the distances of the other points in a significant way. For example, there may be a campaign that existed for just that movie and none of the other movies listed. One could increase the weights for the actions associated with that campaign without altering the other points. This would reflect the fact that participation in this unique campaign reflects a strong affinity and becomes a predictor for future success.

The modification of the weights can be performed using a number of optimization process, and the error measure and expected curve may also vary (for example, quadratic, polynomial, or logarithmic).

Since the affinity score becomes modified for all streams that fall within the same class, the behaviors of all users in the class are accounted for similarly. For streams where a business event has not occurred yet, the affinity score becomes an accurate predictor or probability determination of the outcome by performing a regression of the optimized data. For streams that, even after optimization, do not correlate well, this can be an indicator that the keywords and other criteria for the stream are too broad. For example, suppose a stream is made for a movie whose name is shared with a common English language phrase. The results may not converge towards a linear relationship well since many mentions of the keyword occur out of context. This would be an indicator to the system and/or an operator that the stream should be constrained to a more narrow focus.

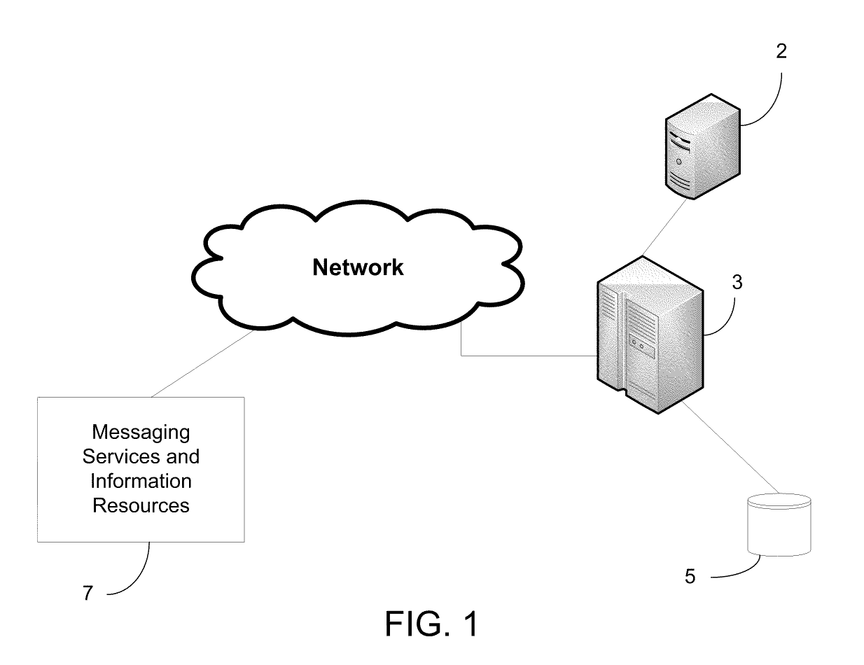

A measurement and scoring social network activities system in accordance with various embodiments of the invention is shown in FIG. 1. The system includes an activity server 3 that is coupled with an activity database 5 and is in network communication with a plurality of messaging services and information sources 7. The messaging services and information source may include but is not limited to such services provided by Twitter, Facebook, etc. The activity server receives user generated activities, such as messages, logins, purchases and so forth, from the plurality of messaging services and information sources. In one embodiment, the activity server retrieves or fillers the received activities to obtain activities that match a particular set of keywords. The activity server 3 in one embodiment assigns a type (e.g., a mention, trending topic, pattern, etc.) to the obtained or received activities. Some or all of the activities are sorted and grouped into streams. The activity streams are stored in stream records. The activity server categorizes the stream records by associating the stream records to topic data. In one embodiment, a campaign selected by the activity server and associated with one or more stream records. In one embodiment, a campaign is an application operating on one or more campaign servers 2. In one embodiment, the campaign servers could also be included in the messaging services and information sources 7. In one embodiment, the stream records include but is not limited to a set of activities with an associated a campaign, user identifier and an action identifier.

The campaign and/or activity server maintains and adjusts campaign records that includes but is not limited to an activity type associated with a weight or a likelihood measurement. The campaign and/or activity servers in one embodiment also calculate affinity scores for particular campaigns and/or user activities or types that can be associated with a particular user identifier associated in the stream records. As a result, for example, with the affinity scores, the activity and/or campaign servers can track and supply likelihood or probability indicators of particular activities, campaigns and/or users effect or impact towards a particular identified or specified end result (such as increased revenue). Thus, in one embodiment, the activity server or application through interaction with the campaign server or application, activity database and/or the message and information sources can receive requests to identify a particular activity impact or affinity that results in a particular goal in which the activity server can return one or more such activities.

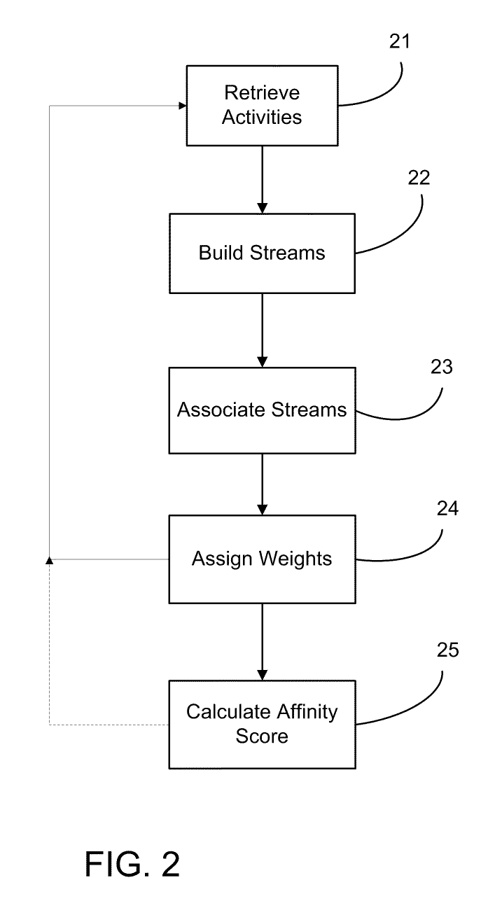

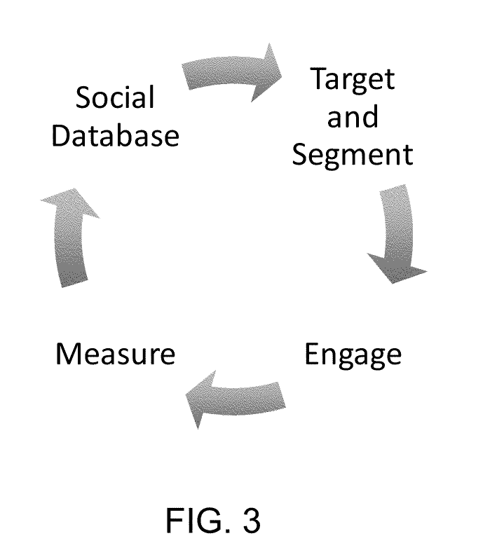

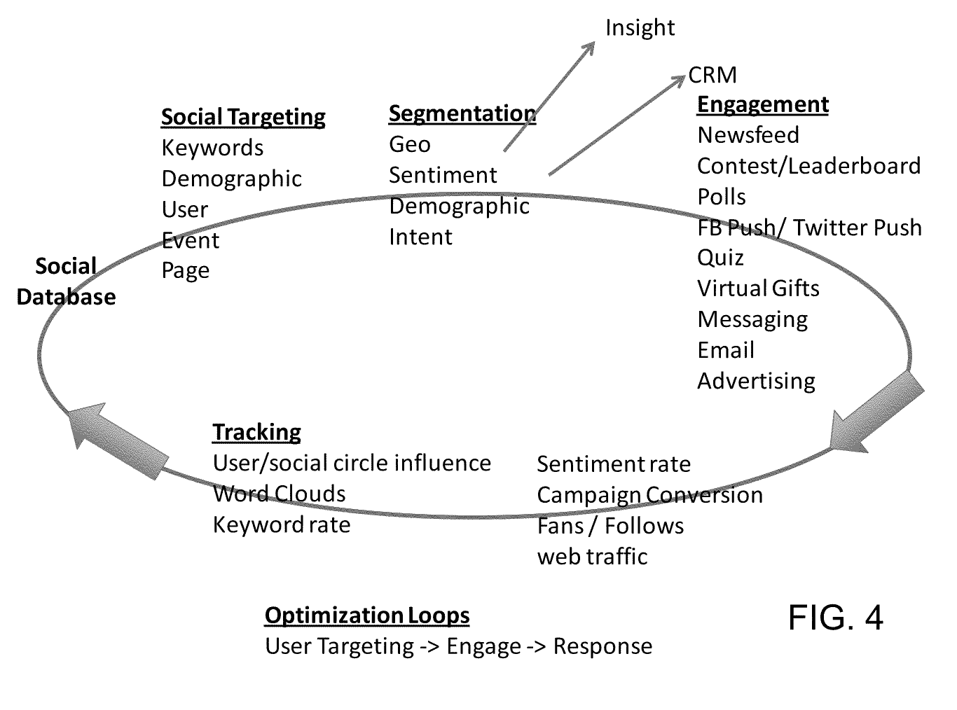

In FIG. 2, measurement and scoring social network activities process in accordance with various embodiments of the invention is illustrated. Initially, social network activities are retrieved (21). The activities in one embodiment are retrieved based on one or more keywords. Streams are built from the retrieved activities (22) and the built streams are associated with campaigns (23). The activities associated within campaigns are assigned weights (24). The process repeats as additional activities are retrieved (21) and associated with streams and campaigns (22-23) and weights are adjusted (24). Affinity scores can also be calculated (25) for each or a particular set of iterations of the process or can result in providing a termination point of the process to return one or more affinity scores to a requester application or server. FIGS. 3-4 illustrate measurement and scoring social network activities systems and processes in accordance with embodiments of the invention.

Although the present invention has been described in certain specific aspects, many additional modifications and variations would be apparent to those skilled in the art. It is therefore to be understood that the present invention may be practiced otherwise than specifically described, including various changes in the size, shape and materials, without departing from the scope and spirit of the present invention. Thus, embodiments of the present invention should be considered in all respects as illustrative and not restrictive.

What is claimed:

1. A method of determining user affinity to a specific advertising campaign, comprising:
receiving activity information at a server from user devices;
building streams of activity information using the server;
relating the streams of activity information to topic data using the server;
assigning weights to specific types of activity information that are associated with an advertising campaign using the server; and
calculating an affinity score with respect to the advertising campaign based upon the streams of activity information and the weights using the server.
